(19) United States
(12) Patent Application Publication
(10) Pub. No.: US 2017/0057011 A1
(43) Pub. Date: Mar. 2, 2017

(54) A Processing Head for a Hybrid Additive/Subtractive Manufacturing Center

(71) Applicant: DMG Mori Advanced Solutions Development, Hoffman Estates, IL (US)

(72) Inventors: Gregory A. Hyatt, South Barrington, IL (US); Nitin Chaphalkar, Schaumburg, IL (US); Karl Hranka, Chicago, IL (US); Michael J. Panzarella, Addison, IL (US)

(73) Assignee: DMG Mori Advanced Solutions Development, Hoffman Estates, IL (US)

(21) Appl. No.: 15/119,422

(22) PCT Filed: Feb. 20, 2015
(86) PCT No.: PCT/US2015/016907

§ 371 Date: Aug. 17, 2016

Related U.S. Application Data
(60) Provisional application No. 61/942,453, filed on Feb. 20, 2014.

(51) Int. Cl. B23K 26/144

(52) U.S. Cl. CPC B23K 26/144

(57) ABSTRACT

A processing head assembly is provided for use with a movable tool holder of a machine tool. The processing head assembly includes an upper processing head coupled to the movable tool holder and having a body defining a socket, and a feed powder/propellant port coupled to the body and operably coupled to a feed powder/propellant supply. The processing head assembly further includes a lower processing head having a base configured to be releasably coupled to the socket, and a nozzle coupled to the base and defining a feed powder/propellant interface configured to detachably couple to the feed powder/propellant port and a nozzle exit orifice.

### BACKGROUND

Technical Field

The present disclosure generally relates to computed numerically controlled manufacturing centers, and more particularly, to hybrid manufacturing centers capable of performing both additive and subtractive manufacturing procedures.

Description of the Related Art

Traditionally, materials are processed into desired shapes and assemblies through a combination of rough fabrication techniques (e.g., casting, rolling, forging, extrusion, and stamping) and finish fabrication techniques (e.g., machining, welding, soldering, polishing). Producing a complex assembly in final, usable form (“net shape”), which may require not only forming the part with the desired materials in the proper shapes but also providing the part with the desired combination of metallurgical properties (e.g., various heat treatments, work hardening, complex microstructure), typically requires considerable investment in time, tools, and effort.

One or more of the rough and finish processes may be performed using manufacturing centers, such as Computer Numerically Controlled (CNC) machine tools. Such machine tools include lathes, milling machines, grinding machines, and other tool types. More recently, machining centers have been developed, which provide a single machine having multiple tool types and capable of performing multiple different machining processes. Machining centers may generally include one or more tool retainers, such as spindle retainers and turret retainers holding one or more tools, and a workpiece retainer, such as a pair of chucks. The workpiece retainer may be stationary or move (in translation and/or rotation) while a tool is brought into contact with the workpiece, thereby performing a subtractive manufacturing process during which material is removed from the workpiece.

Because of cost, expense, complexity, and other factors, more recently there has been interest in alternative techniques which would allow part or all of the conventional materials fabrication procedures to be replaced by additive manufacturing techniques. In contrast to subtractive manufacturing processes, which focus on precise removal of material from a workpiece, additive manufacturing processes precisely add material, typically in a computer-controlled environment. Additive manufacturing techniques may improve efficiency and reduce waste while expanding manufacturing capabilities, such as by permitting seamless construction of complex configurations which, when using conventional manufacturing techniques, would have to be assembled from a plurality of component parts. For the purposes of this specification and the appended claims, the term ‘plurality’ consistently is taken to mean “two or more.” The opportunity for additive techniques to replace subtractive processes depends on several factors, such as the range of materials available for use in the additive processes, the size and surface finish that can be achieved using additive techniques, and the rate at which material can be added. Additive processes may advantageously be capable of fabricating complex precision net-shape components ready for use. In some cases, however, the additive process may generate “near-net shape” products that require some degree of finishing.

In general, additive and subtractive processing techniques have developed substantially independently, and therefore have overlooked synergies that may result from combining these two distinct types of processes and the apparatus for performing them.

### SUMMARY OF THE DISCLOSURE

In accordance with one aspect of the present disclosure, processing head assembly is provided for use with a movable tool holder of a machine tool. The processing head assembly includes an upper processing head coupled to the movable tool holder and having a body defining a socket, and a feed powder/propellant port coupled to the body and operably coupled to a feed powder/propellant supply. The processing head assembly further includes a lower processing head having a base configured to be releasably coupled to the socket, and a nozzle coupled to the base and defining a feed powder/propellant interface configured to detachably couple to the feed powder/propellant port and a nozzle exit orifice.

In accordance with another aspect of the present disclosure, a machine tool is provided for use with a feed powder/propellant supply and a fabrication energy supply. The machine tool includes a first tool holder carrying a substrate, a second tool holder, and a processing head assembly. The processing head assembly includes an upper processing head coupled to the second tool holder and including a body defining a socket, and a feed powder/propellant port coupled to the body and operably coupled to the feed powder/propellant supply. The processing head assembly further includes a lower processing head having a base configured to be releasably coupled to the socket, and a nozzle coupled to the base and defining a feed powder/propellant interface configured to detachably couple to the feed powder/propellant port and a nozzle exit orifice fluidly communicating with the feed powder/propellant interface. A fabrication energy outlet is operatively coupled to the fabrication energy supply. Machine control circuitry is operatively coupled to the first tool holder, the second tool holder, and the fabrication energy outlet, the machine control circuitry comprising one or more central processing units and one or more memory devices, the one or more memory devices storing instructions that, when executed by the one or more central processing units, cause the machine control circuitry to cause relative movement of the first tool holder, second tool holder, and fabrication energy outlet to direct fabrication energy and feed powder/propellant toward a target area on the substrate, thereby to perform an additive manufacturing process during which material is added to the substrate.

In accordance with another aspect of the present disclosure, a machine tool is provided for use with a feed powder/propellant supply and a fabrication energy supply. The machine tool includes a first tool holder coupled to a substrate, a second tool holder, and a processing head assembly. The processing head assembly includes an upper processing head coupled to the second tool holder and having a body defining a socket, a feed powder/propellant port coupled to the body and operably coupled to the feed powder/propellant supply, and a fabrication energy port coupled to the body and operably coupled to the fabrication energy supply. The processing head assembly further includes a lower processing head having a base configured to be releasably coupled to the socket, a fabrication energy interface coupled to the base and configured to detachably couple to the fabrication energy port, a nozzle coupled to the base and defining a feed powder/propellant interface configured to detachably couple to the feed powder/propellant port, a nozzle exit orifice fluidly communicating with the feed powder/propellant interface, a fabrication energy outlet operably coupled to the fabrication energy interface, an optic chamber disposed between the fabrication energy interface and the fabrication energy outlet, and a focusing optic disposed in the optic chamber. Machine control circuitry is operatively coupled to the first tool holder and the second tool holder, and the fabrication energy outlet, the machine control circuitry comprising one or more central processing units and one or more memory devices, the one or more memory devices storing instructions that, when executed by the one or more central processing units, cause the machine control circuitry to cause relative movement of the first tool holder and second tool holder to direct fabrication energy and feed powder/propellant toward a target area on the substrate, thereby to perform an additive manufacturing process during which material is added to the substrate.

In accordance with another aspect of the present disclosure, which may be combined with one or more of the other aspects identified herein, the upper processing head may further includes a fabrication energy port coupled to the body and operably coupled to a fabrication energy supply, and the lower processing head may further include a fabrication energy interface coupled to the base and configured to detachably couple to the fabrication energy port, a fabrication energy outlet, an optic chamber disposed between the fabrication energy interface and the fabrication energy outlet, and a focusing optic disposed in the optic chamber.

In accordance with another aspect of the present disclosure, which may be combined with one or more of the other aspects identified herein, the nozzle further defines the nozzle exit orifice.

In accordance with another aspect of the present disclosure, which may be combined with one or more of the other aspects identified herein, the nozzle exit orifice surrounds the fabrication energy outlet.

In accordance with another aspect of the present disclosure, which may be combined with one or more of the other aspects identified herein, the upper processing head further includes a shield gas port coupled to the body and operably coupled to a shield gas supply, and the lower processing head further includes a shield gas interface coupled to the base and configured to detachably couple to the shield gas port.

In accordance with another aspect of the present disclosure, which may be combined with one or more of the other aspects identified herein, the upper processing head further includes a coolant port coupled to the body and operably coupled to a coolant supply, and the lower processing head further includes a coolant interface coupled to the base and configured to detachably couple to the coolant port.

In accordance with another aspect of the present disclosure, which may be combined with one or more of the other aspects identified herein, the feed powder/propellant interface, shield gas interface, coolant interface, and fabrication energy interface are configured to respectively couple to the feed powder/propellant port, shield gas port, coolant port, and fabrication energy port simultaneously as the base is coupled to the socket.

In accordance with another aspect of the present disclosure, which may be combined with one or more of the other aspects identified herein, the upper processing head further includes an enclosure coupled to the body and defining the fabrication energy port, and a first mirror disposed in the enclosure and optically coupled to the fabrication energy port, and the lower processing head further includes a second mirror disposed in the optic chamber, the second mirror being configured to optically couple with the first mirror when the base of the lower processing head is coupled to the socket of the upper processing head.

In accordance with another aspect of the present disclosure, which may be combined with one or more of the other aspects identified herein, the fabrication energy supply comprises a laser.

In accordance with another aspect of the present disclosure, which may be combined with one or more of the other aspects identified herein, the upper processing head comprises a spindle of the machine tool.

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a front elevation of a computer numerically controlled machine in accordance with one embodiment of the present disclosure, shown with safety doors closed.

FIG. 2 is a front elevation of a computer numerically controlled machine illustrated in FIG. 1, shown with the safety doors open.

FIG. 3 is a perspective view of certain interior components of the computer numerically controlled machine illustrated in FIGS. 1 and 2, depicting a machining spindle, a first chuck, a second chuck, and a turret.

FIG. 4 a perspective view, enlarged with respect to FIG. 3 illustrating the machining spindle and the horizontally and vertically disposed rails via which the spindle may be translated.

FIG. 5 is a side view of the first chuck, machining spindle, and turret of the machining center illustrated in FIG. 1.

FIG. 6 is a view similar to FIG. 5 but in which a machining spindle has been translated in the Y-axis.

FIG. 7 is a front view of the spindle, first chuck, and second chuck of the computer numerically controlled machine illustrated in FIG. 1, including a line depicting the permitted path of rotational movement of this spindle.

FIG. 8 is a perspective view of the second chuck illustrated in FIG. 3, enlarged with respect to FIG. 3.

FIG. 9 is a perspective view of the first chuck and turret illustrated in FIG. 2, depicting movement of the turret and turret stock in the Z-axis relative to the position of the turret in FIG. 2.

FIG. 10 is a front view of the computer numerically controlled machine of FIG. 1 with the front doors open.

FIG. 11 is a perspective view of an exemplary tool changer of the machine of FIG. 1.

FIGS. 12(a) to 12(d) are perspective views showing operation of the tool changer of FIG. 11.

FIG. 13 is a schematic illustration of a material deposition assembly for use with the computer numerically controlled machine of FIG. 1.

FIG. 14 is a side elevation view of a material deposition assembly having a removable deposition head.

FIG. 15 is a side elevation view of an alternative embodiment of a material deposition assembly having a removable deposition head.

FIG. 16 is a side elevation view, in partial cross-section, of a lower processing head used in the material deposition assembly of FIG. 14.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

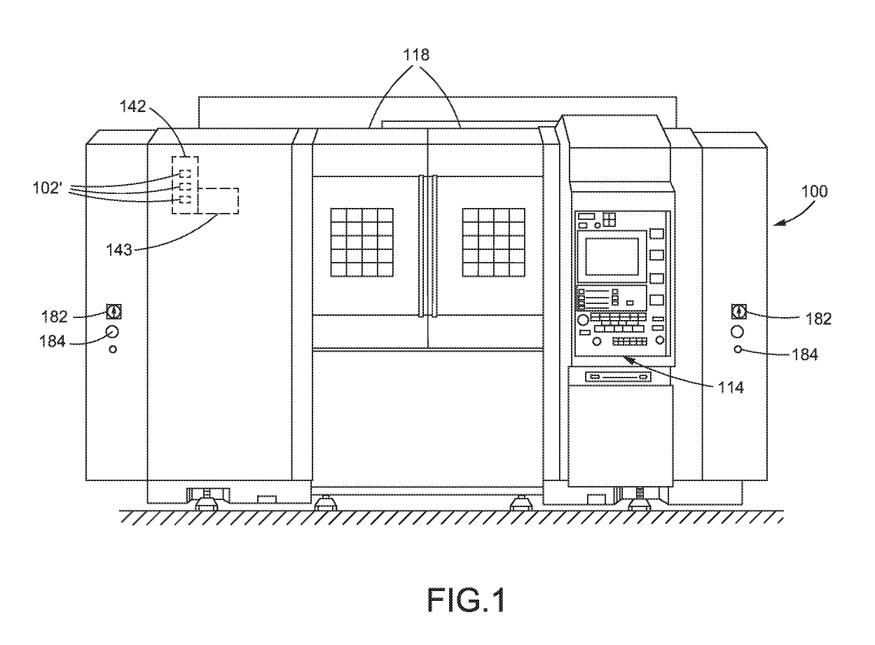

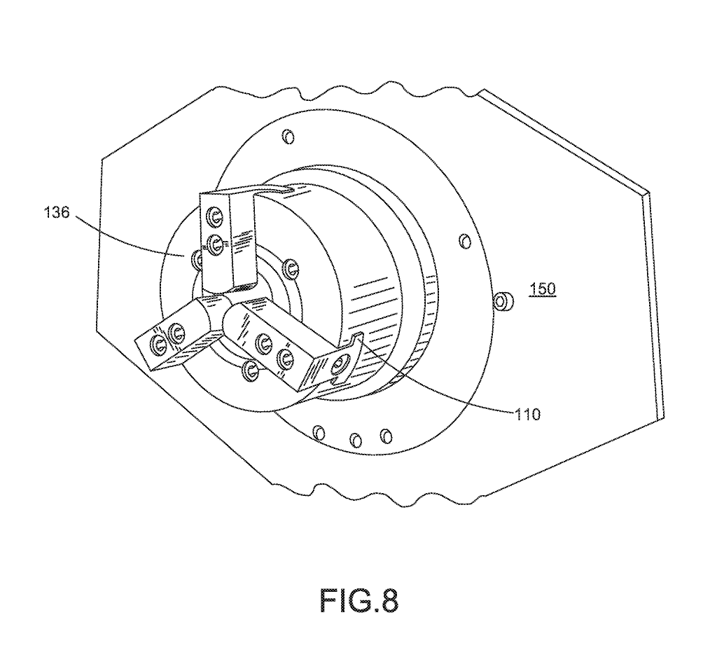

Any suitable apparatus may be employed in conjunction with the methods disclosed herein. In some embodiments, the methods are performed using a computer numerically controlled machine, illustrated generally in FIGS. 1-10. A computer numerically controlled machine is itself provided in other embodiments. The machine 100 illustrated in FIGS. 1-10 is an NT-series machine, versions of which are available from DMG/Mori Seiki USA, the assignee of the present application. Alternatively, DMG/Mori Seiki's DMU-65 (a five-axis, vertical machine tool) machine tool, or other machine tools having different orientations or numbers of axes, may be used in conjunction with the apparatus and methods disclosed herein.

In general, with reference to the NT-series machine illustrated in FIGS. 1-3, one suitable computer numerically controlled machine 100 has at least a first retainer and a second retainer, each of which may be a tool retainer (such as a spindle retainer associated with spindle 144 or a turret retainer associated with a turret 108) or a workpiece retainer (such as chucks 110, 112). In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

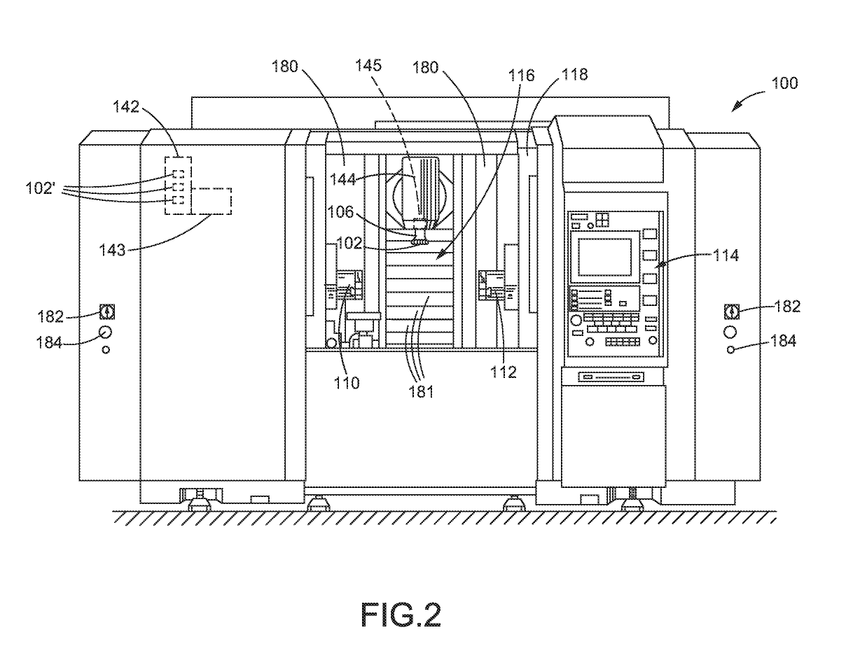

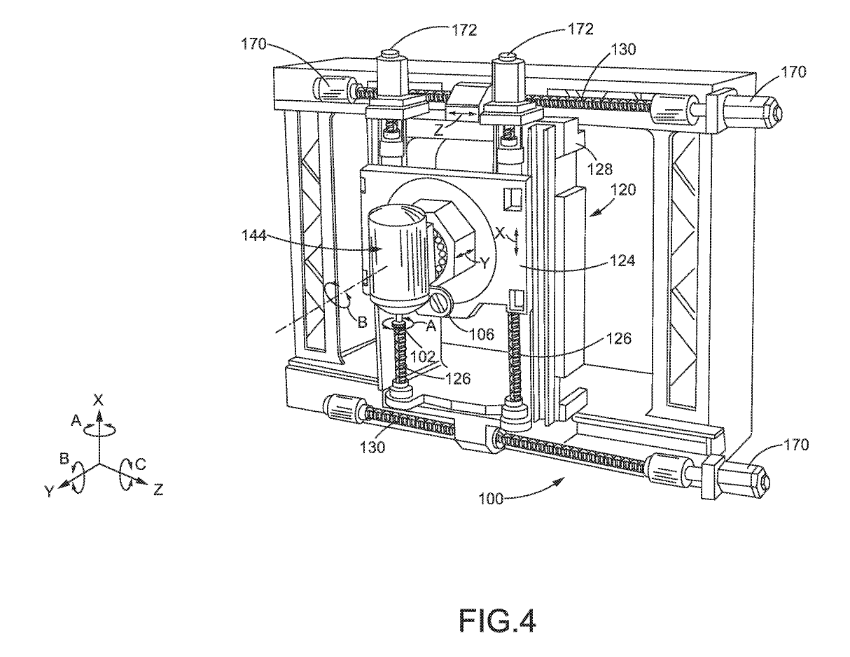

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the machine chamber 116 to prevent injury to the user or interference in the operation of the computer numerically controlled machine 100. The safety doors 118 can be opened to permit access to the machine chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface 114 allows an operator to control the second computer system. Collectively, the machine control system and the user interface system, together with the various mechanisms for control of operations in the machine, may be considered a single computer control system.

The computer control system may include machine control circuitry having a central processing unit (CPU) connected to a main memory. The CPU may include any suitable processor(s), such as those made by Intel and AMD. By way of example, the CPU may include a plurality of microprocessors including a master processor, a slave processor, and a secondary or parallel processor. Machine control circuitry, as used herein, comprises any combination of hardware, software, or firmware disposed in or outside of the machine 100 that is configured to communicate with or control the transfer of data between the machine 100 and a bus, another computer, processor, device, service, or network. The machine control circuitry, and more specifically the CPU, comprises one or more controllers or processors and such one or more controllers or processors need not be disposed proximal to one another and may be located in different devices or in different locations. The machine control circuitry, and more specifically the main memory, comprises one or more memory devices which need not be disposed proximal to one another and may be located in different devices or in different locations. The machine control circuitry is operable to execute all of the various machine tool methods and other processes disclosed herein.

In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically controlled machine 100 may have a tool magazine 142 and a tool changer 143. These cooperate with the spindle 144 to permit the spindle to operate with any one of multiple tools. Generally, a variety of tools may be provided; in some embodiments, multiple tools of the same type may be provided.

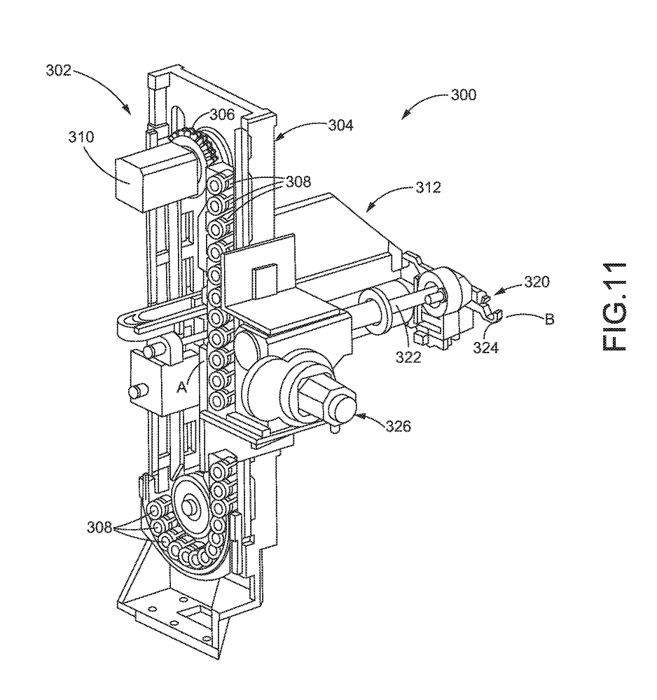

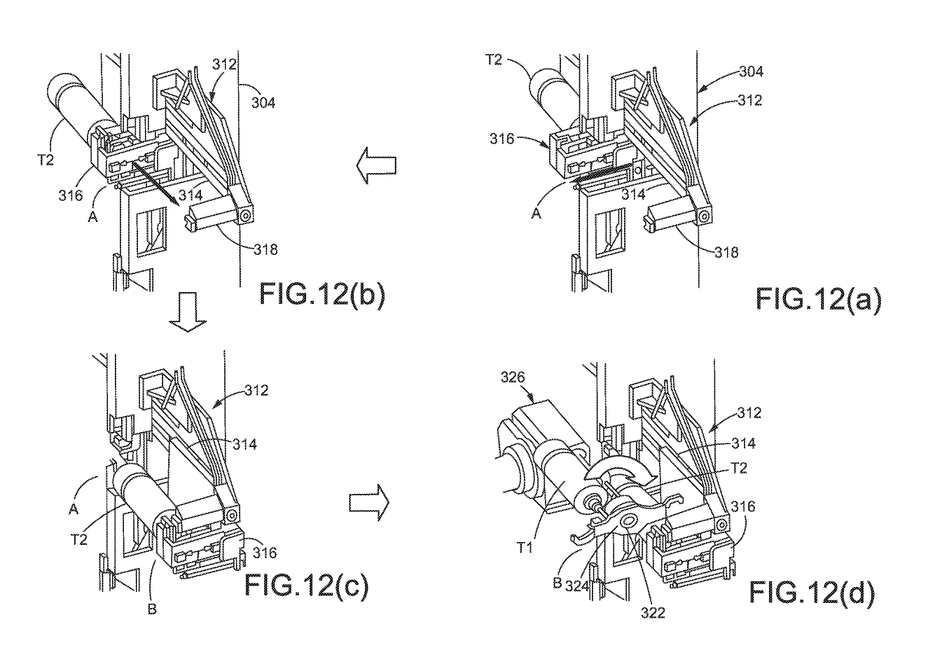

An exemplary embodiment of a tool changer 300 is illustrated in greater detail in FIGS. 11 and 12(a) to 12(d). The tool changer 300 includes a tool magazine 302 for holding a plurality of tools. The tool magazine 302 may include a magazine base 304 and an endless carrier 306 supported for rotation relative to the magazine base 304. A plurality of tool pots 308 are coupled to the endless carrier 306 at a predetermined pitch, each tool pot 308 being configured to detachably receive an associated tool. A rotary motor 310 is operably coupled to the endless carrier 306 to index the tool magazine 302 as desired.

The tool changer 300 also includes a tool carrier 312 for extracting a subsequent tool T2 from a tool delivery position A of the tool magazine 302 and transferring it to a tool change position B. As best shown in FIGS. 11 and 12a-d, the tool carrier 312 may include a transfer rail 314 coupled to the magazine base 304 and extending from the tool delivery position A to the tool change position B. A transfer support 316 is slidably coupled to the transfer rail 314 and configured to engage the subsequent tool T2 positioned at the tool delivery position A from the tool pot 308. A transfer motor 318 is operably coupled to the transfer support 316 to reciprocate the transfer support 316 between the tool delivery position A and the tool change position B, thereby to remove the subsequent tool T2 from the tool pot 308.

The illustrated tool changer 300 further includes a tool exchange assembly 320 for exchanging a preceding tool T1 held by the spindle 144 for the subsequent tool T2 presented at the tool change position B. the tool exchange assembly 320 may include an exchange shaft 322 supported by and rotatable relative to the magazine base 304 and an exchange arm 324 coupled to the exchange shaft 322. An exchange drive 326 is operably coupled to the exchange shaft 322 to move the exchange shaft 322 in both axial and rotational directions.

In operation, the tool changer 300 may be used to change the tool that is coupled to the spindle 144. The tool magazine 302 rotary-indexes the subsequent tool T2 to position it at the tool delivery position A, as shown in FIG. 12(a). The transfer support 316 engages the subsequent tool T2 positioned at the tool delivery position A and transfers it to the tool change position B, as shown in FIGS. 12(b) and 12(c). Next, the exchange arm 324 changes the preceding tool T1 attached to the spindle 144 to the subsequent tool T2 held by the transfer support 316, as shown in FIG. 12(d). Thereafter, the preceding tool T1 may be returned to a predetermined one of the tool pots 308 of the tool magazine 302, and the subsequent tool T2 attached to the spindle 144 may be used in a subsequent process.

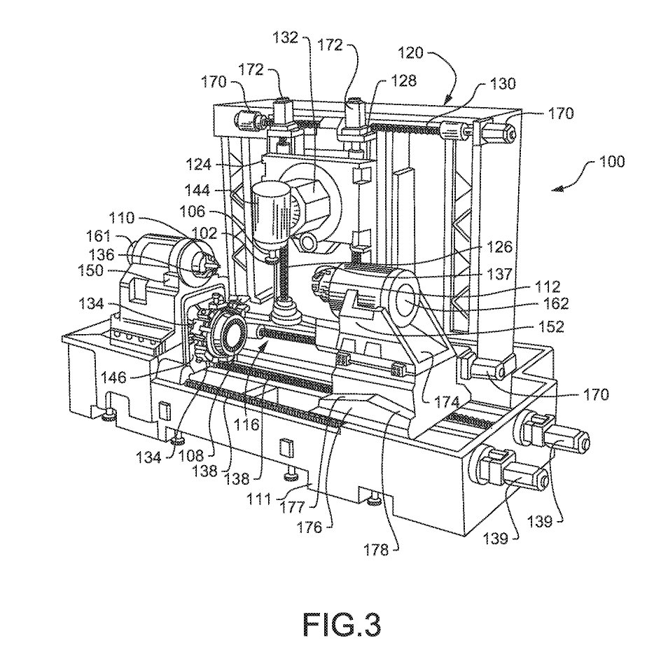

The spindle 144 is mounted on a carriage assembly 120 that allows for translational movement along the X- and Z-axis, and on a ram 132 that allows the spindle 144 to be moved in the Y-axis. The ram 132 is equipped with a motor to allow rotation of the spindle in the B-axis, as set forth in more detail below. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

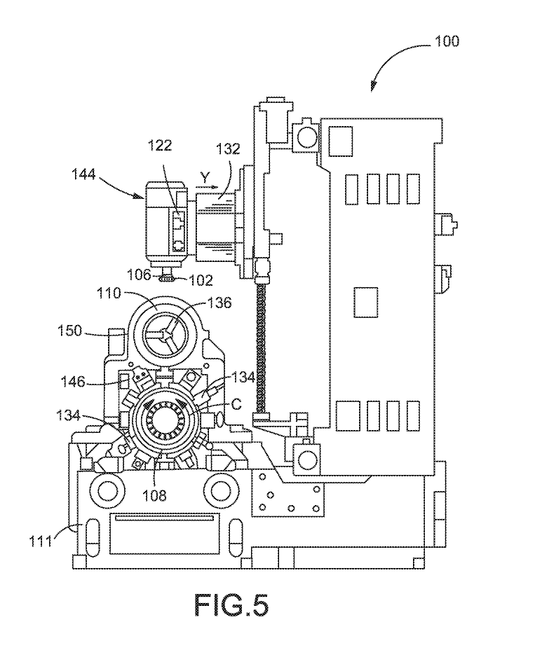

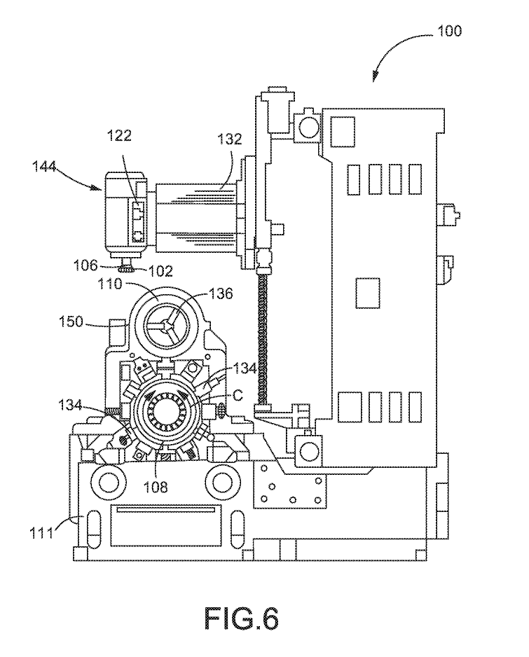

The spindle 144 holds the tool 102 by way of a spindle connection and a tool retainer 106. The spindle connection 145 (shown in FIG. 2) is connected to the spindle 144 and is contained within the spindle 144. The tool retainer 106 is connected to the spindle connection and holds the tool 102. Various types of spindle connections are known in the art and can be used with the computer numerically controlled machine 100. Typically, the spindle connection is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the second stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

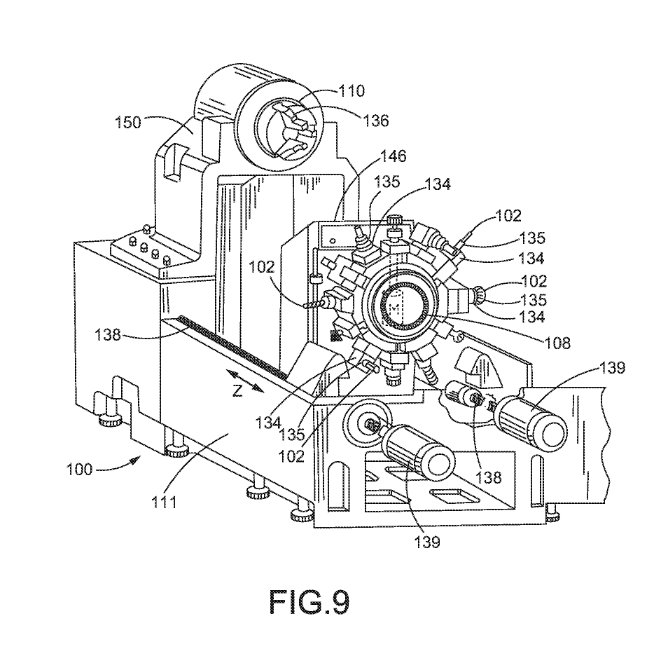

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool retainer 135 or other connection for connecting to a tool. Since the turret 108 can have a variety of turret connectors 134 and tool retainers 135, a variety of different tools can be held and operated by the turret 108. The turret 108 may be rotated in a C′ axis to present different ones of the tool retainers (and hence, in many embodiments, different tools) to a workpiece.

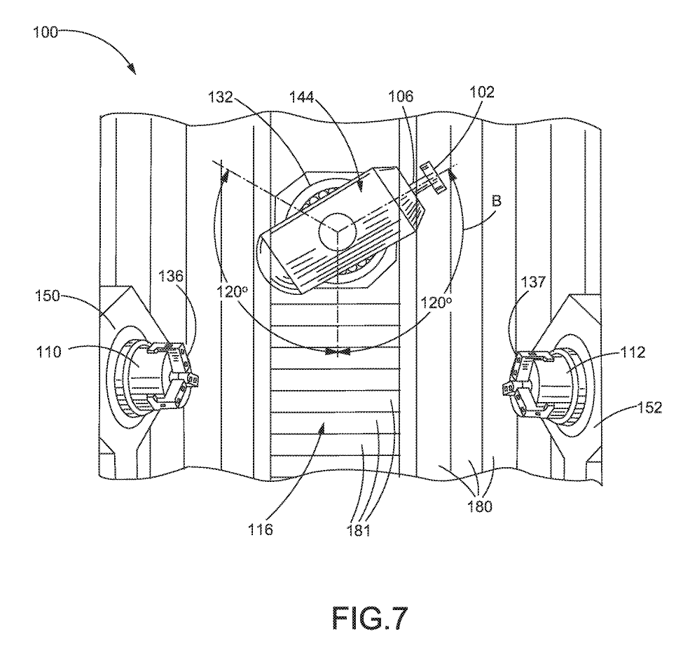

It is thus seen that a wide range of versatile operations may be performed. With reference to tool 102 held in tool retainer 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changer 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120 degrees to either side of the vertical. Movement in the Y direction and rotation in the B axis are powered by motors (not shown) that are located behind the carriage 124.

Generally, as seen in FIGS. 2 and 7, the machine is provided with a plurality of vertically disposed leaves 180 and horizontal disposed leaves 181 to define a wall of the machine chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the machine chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of tools known in the art or otherwise found to be suitable. For instance, the tool 102 may be a cutting tool such as a milling tool, a drilling tool, a grinding tool, a blade tool, a broaching tool, a turning tool, or any other type of cutting tool deemed appropriate in connection with a computer numerically controlled machine 100. Additionally or alternatively, the tool may be configured for an additive manufacturing technique, as discussed in greater detail below. In either case, the computer numerically controlled machine 100 may be provided with more than one type of tool, and via the mechanisms of the tool changer 143 and tool magazine 142, the spindle 144 may be caused to exchange one tool for another. Similarly, the turret 108 may be provided with one or more tools 102, and the operator may switch between tools 102 by causing rotation of the turret 108 to bring a new turret connector 134 into the appropriate position.

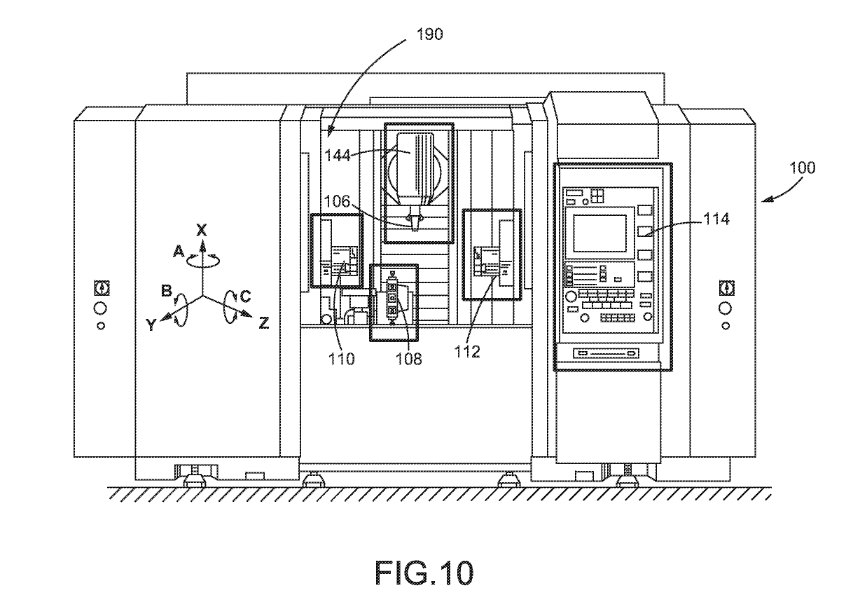

The computer numerically controlled machine 100 is illustrated in FIG. 10 with the safety doors open. As shown, the computer numerically controlled machine 100 may be provided with at least a tool retainer 106 disposed on a spindle 144, a turret 108, one or more chucks or workpiece retainers 110, 112 as well as a user interface 114 configured to interface with a computer control system of the computer numerically controlled machine 100. Each of the tool retainer 106, spindle 144, turret 108 and workpiece retainers 110, 112 may be disposed within a machining area 190 and selectively rotatable and/or movable relative to one another along one or more of a variety of axes.

As indicated in FIG. 10, for example, the X, Y, and Z axes may indicate orthogonal directions of movement, while the A, B, and C axes may indicate rotational directions about the X, Y, and Z axes, respectively. These axes are provided to help describe movement in a three-dimensional space, and therefore, other coordinate schemes may be used without departing from the scope of the appended claims. Additionally, use of these axes to describe movement is intended to encompass actual, physical axes that are perpendicular to one another, as well as virtual axes that may not be physically perpendicular but in which the tool path is manipulated by a controller to behave as if they were physically perpendicular.

With reference to the axes shown in FIG. 10, the tool retainer 106 may be rotated about a B-axis of the spindle 144 upon which it is supported, while the spindle 144 itself may be movable along an X-axis, a Y-axis and a Z-axis. The turret 108 may be movable along an XA-axis substantially parallel to the X-axis and a ZA-axis substantially parallel to the Z axis. The workpiece retainers 110, 112 may be rotatable about a C-axis, and further, independently translatable along one or more axes relative to the machining area 190. While the computer numerically controlled machine 100 is shown as a six-axis machine, it is understood that the number of axes of movement is merely exemplary, as the machine may be capable of movement in less than or greater than six axes without departing from the scope of the claims.

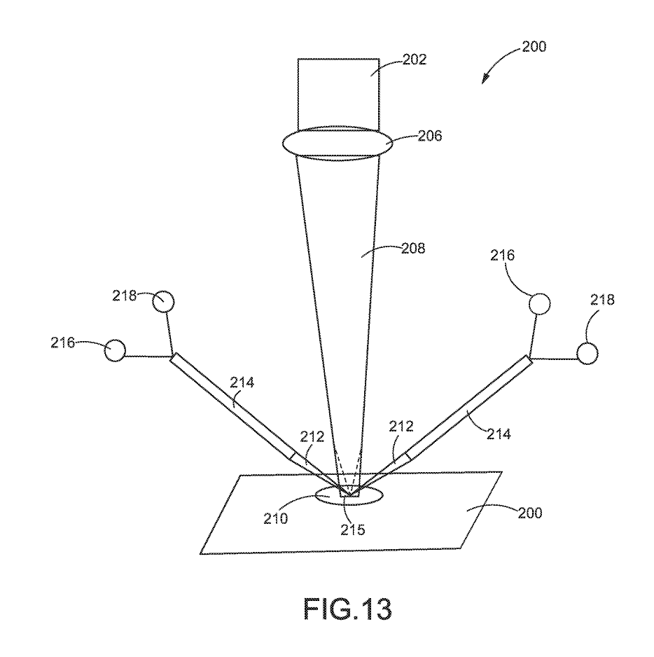

The computer numerically controlled machine 100 may include a material deposition assembly for performing additive manufacturing processes. An exemplary material deposition assembly 200 is schematically illustrated in FIG. 13 as including a fabrication energy beam 202 capable of being directed toward a substrate 204. The substrate 204 may be supported by one or more of the workpiece retainers, such as chucks 110, 112. The material deposition assembly 200 may further include an optic 206 that may direct a concentrated energy beam 208 toward the substrate 204, however the optic 206 may be omitted if the concentrated energy beam 208 has sufficiently large energy density. The fabrication energy beam 202 may be a laser beam, an electron beam, an ion beam, a cluster beam, a neutral particle beam, a plasma jet, or a simple electrical discharge (arc). The concentrated energy beam 208 may have an energy density sufficient to melt a small portion of the growth surface substrate 204, thereby forming a melt-pool 210, without losing substrate material due to evaporation, splattering, erosion, shock-wave interactions, or other dynamic effects. The concentrated energy beam 208 may be continuous or intermittently pulsed.

The melt-pool 210 may include liquefied material from the substrate 204 as well as added feed material. Feed material may be provided as a feed powder that is directed onto the melt-pool 210 in a feed powder/propellant gas mixture 212 exiting one or more nozzles 214. The nozzles 214 may fluidly communicate with a feed powder reservoir 216 and a propellant gas reservoir 218. The nozzles 214 create a flow pattern of feed powder/propellant gas mixture 212 that may substantially converge into an apex 215 or region of smallest physical cross-section so that the feed powder is incorporated into the melt-pool 210. As the material deposition assembly 200 is moved relative to the substrate 204, the assembly traverses a tool path that forms a bead layer on the substrate 204. Additional bead layers may be formed adjacent to or on top of the initial bead layer to fabricate solid, three-dimensional objects.

Depending on the materials used and the object tolerances required, it is often possible to form net shape objects, or objects which do not require further machining for their intended application (polishing and the like are permitted). Should the required tolerances be more precise than are obtainable by the material deposition assembly 200, a subtractive finishing process may be used. When additional finishing machining is needed, the object generated by the material deposition assembly 200 prior to such finishing is referred to herein as “near-net shape” to indicate that little material or machining is needed to complete the fabrication process.

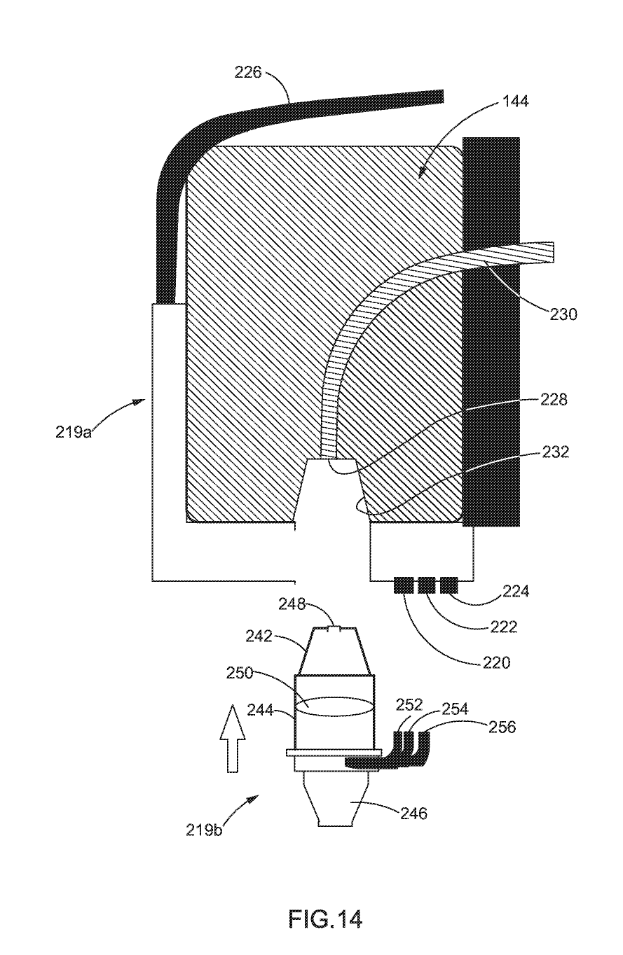

The material deposition assembly 200 may be incorporated into the computer numerically controlled machine 100, as best shown in FIG. 14. In this exemplary embodiment, the material deposition assembly 200 includes a processing head assembly 219 having an upper processing head 219a and a lower processing head 219b. The lower processing head 219b is detachably coupled to the upper processing head 219a to permit the upper processing head 219a to be used with different lower processing heads 219b. The ability to change the lower processing head 219b may be advantageous when different deposition characteristics are desired, such as when different shapes and/or densities of the fabrication energy beam 202 and/or feed powder/propellant gas mixture 212 are needed.

More specifically, the upper processing head 219a may include the spindle 144. A plurality of ports may be coupled to the spindle 144 and are configured to interface with the lower processing head 219b when connected. For example, the spindle 144 may carry a feed powder/propellant port 220 fluidly communicating with a powder feed supply (not shown), which may include a feed powder reservoir and a propellant reservoir. Additionally, the spindle 144 may carry a shield gas port 222 fluidly communicating with a shield gas supply (not shown), and a coolant port 224 fluidly communicating with a coolant supply (not shown). The feed powder/propellant port 220, shield gas port 222, and coolant port 224 may be connected to their respective supplies either individually or through a harnessed set of conduits, such as conduit assembly 226.

The upper processing head 219a further may include a fabrication energy port 228 operatively coupled to a fabrication energy supply (not shown). In the illustrated embodiment, the fabrication energy supply is a laser connected to the fabrication energy port 228 by laser fiber 230 extending through a housing of the spindle 144. The laser fiber 230 may travel through a body of the spindle 144, in which case the fabrication energy port 228 may be located in a socket 232 formed in a bottom of the spindle 144. Therefore, in the embodiment of FIG. 14, the fabrication energy port 228 is disposed inside the socket 232 while the feed powder/propellant port 220, shield gas port 222, and coolant port 224 are disposed adjacent the socket 232. The upper processing head 219a may further include additional optics for shaping the energy beam, such as a collimation lens, a partially reflective mirror, or a curved mirror.

The upper processing head 219a may be selectively coupled to one of a plurality of lower processing heads 219b. As shown in FIG. 14, an exemplary lower processing head 219b may generally include a base 242, an optic chamber 244, and a nozzle 246. Additionally, a nozzle adjustment assembly may be provided to translate, rotate, or otherwise adjust the position and/or orientation of the nozzle 246 relative to the energy beam. The base 242 is configured to closely fit inside the socket 232 to permit releasable engagement between the lower processing head 219b and the upper processing head 219a. In the embodiment of FIG. 14, the base 242 also includes a fabrication energy interface 248 configured to detachably couple to the fabrication energy port 228. The optic chamber 244 may be either empty or it may include a final optic device, such as a focusing optic 250 configured to provide the desired concentrated energy beam. The lower processing head 219b may further include a feed powder/propellant interface 252, a shield gas interface 254, and a coolant interface 256 configured to operatively couple with the feed powder/propellant port 220, shield gas port 222, and coolant port 224, respectively.

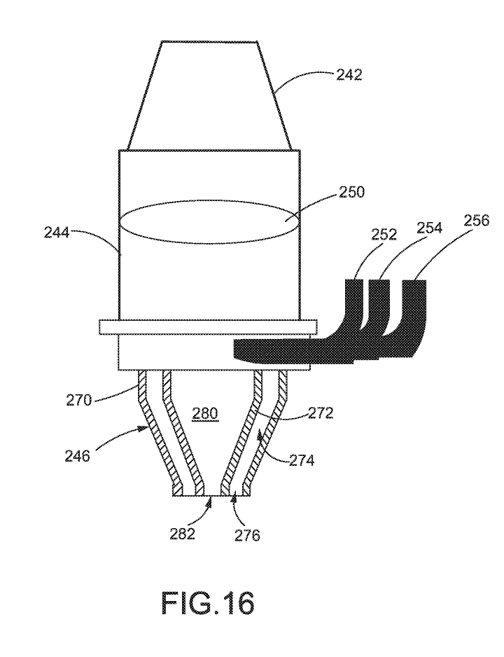

The nozzle 246 may be configured to direct feed powder/propellant toward the desired target area. In the embodiment illustrated at FIG. 16, the nozzle 246 includes an outer nozzle wall 270 spaced from an inner nozzle wall 272 to define a powder/propellant chamber 274 in the space between the outer and inner nozzle walls 270, 272. The powder/propellant chamber 274 fluidly communicates with the feed powder/propellant interface 252 at one end and terminates at an opposite end in a nozzle exit orifice 276. In the exemplary embodiment, the nozzle exit orifice 276 has an annular shape, however other the nozzle exit orifice 276 may have other shapes without departing from the scope of the present disclosure. The powder/propellant chamber 274 and nozzle exit orifice 276 may be configured to provide one or more jets of feed powder/propellant at the desired angle of convergence. The nozzle 246 of the illustrated embodiment may deliver a single, conical-shaped jet of powder/propellant gas. It will be appreciated, however, that the nozzle exit orifice 276 may be configured to provide multiple discrete jets of powder/propellant gas. Still further, the resulting jet(s) of powder/propellant gas may have shapes other than conical.

The nozzle 246 may further be configured to permit the fabrication energy beam to pass through the nozzle 246 as it travels toward the target area. As best shown in FIG. 16, the inner nozzle wall 272 defines a central chamber 280 having a fabrication energy outlet 282 aligned with the optic chamber 244 and the optional focusing optic 250. Accordingly, the nozzle 246 permits the beam of fabrication energy to pass through the nozzle 246 to exit the lower processing head 219b.

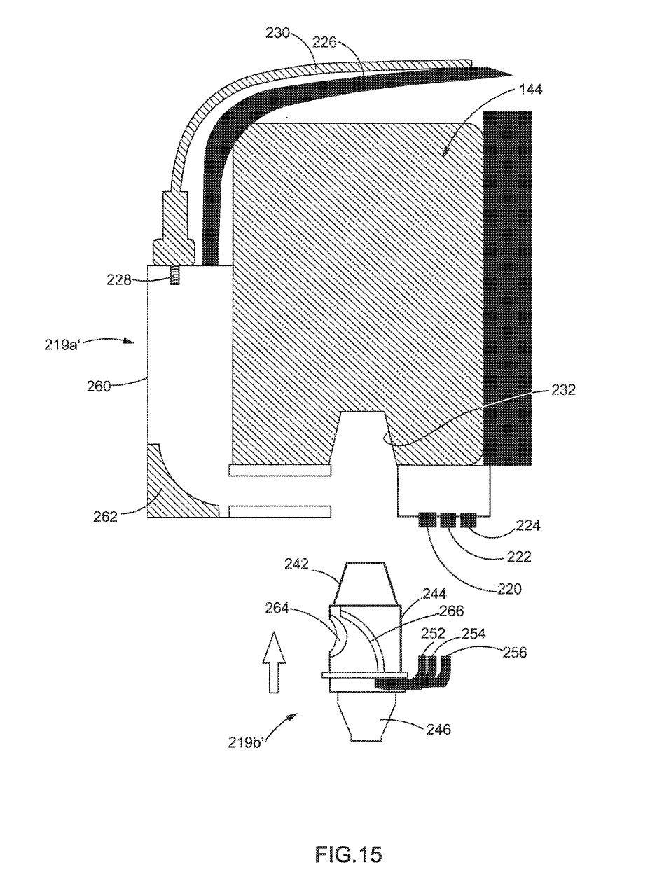

In an alternative embodiment, an upper processing head 219a′ may have the fabrication energy port 228 provided outside of the housing of the spindle 144 as best shown in FIG. 15. In this embodiment, the fabrication energy port 228 is located on an enclosure 260 provided on a side of the spindle 144, and therefore, unlike the above embodiment, this port is not provided in the socket 232. The enclosure 260 includes a first mirror 262 for directing the fabrication energy toward a point below the socket 232 of the spindle 144. An alternative lower processing head 219b′ includes an optic chamber 244 that includes a fabrication energy receptacle 264 through which the fabrication energy may pass from the enclosure 260 to an interior of the optic chamber 244. The optic chamber 244 further includes a second mirror 266 for redirecting the fabrication energy through the nozzle 246 and toward the desired target location.

While the exemplary embodiments incorporate the fabrication energy into the processing head assembly 219, it will be appreciated that the fabrication energy may be provided independent of the processing head assembly 219. That is, a separate assembly, such as the turret 108, the first chuck 110, the second chuck 112, or a dedicated robot provided with the machine 100, may be used to direct the fabrication energy toward the substrate 204. In this alternative embodiment, the processing head assembly 219 would omit the fabrication energy port, fabrication energy interface, fabrication energy outlet, optic chamber, and focusing optic.

With the processing head assembly 219 having the upper processing head 219a configured to selectively couple with any one of several lower processing heads 219b, the computer numerically controlled machine 100 may be quickly and easily reconfigured for different additive manufacturing techniques. The tool magazine 142 may hold a set of lower processing heads 219b, wherein each lower processing head in the set has unique specifications suited for a particular additive manufacturing process. For example, the lower processing heads may have different types of optics, interfaces, and nozzle angles that alter the manner in which material is deposited on the substrate. When a particular part must be formed using different additive manufacturing techniques (or may be formed more quickly and efficiently when multiple different techniques are used), the tool changer 143 may be used to quickly and easily change the particular deposition head coupled to the spindle 144. In the exemplary embodiments illustrated in FIGS. 14 and 15, a single attachment step may be used to connect the energy, feed powder/propellant gas, shield gas, and coolant supplies to the deposition head. Similarly, detachment is accomplished in a single disconnect step. Accordingly, the machine 100 may be more quickly and easily modified for different material deposition techniques.

As supplied, the apparatus may or may not be provided with a tool or workpiece. An apparatus that is configured to receive a tool and workpiece is deemed to fall within the purview of the claims recited herein. Additionally, an apparatus that has been provided with both a tool and workpiece is deemed to fall within the purview of the appended claims. Except as may be otherwise claimed, the claims are not deemed to be limited to any tool depicted herein.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

What is claimed is:

1. A processing head assembly for use with a movable tool holder of a machine tool, the processing head assembly comprising:
an upper processing head coupled to the movable tool holder and including:
a body defining a socket; and
a feed powder/propellant port coupled to the body and operably coupled to a feed powder/propellant supply; and
a lower processing head including:
a base configured to be releasably coupled to the socket; and
a nozzle coupled to the base and defining a feed powder/propellant interface configured to detachably couple to the feed powder/propellant port and a nozzle exit orifice.

2. The processing head assembly of claim 1, in which:
the upper processing head further includes a fabrication energy port coupled to the body and operably coupled to a fabrication energy supply; and
the lower processing head further includes:
a fabrication energy interface coupled to the base and configured to detachably couple to the fabrication energy port;
a fabrication energy outlet;
an optic chamber disposed between the fabrication energy interface and the fabrication energy outlet; and
a focusing optic disposed in the optic chamber.

3. The processing head assembly of claim 2, in which the nozzle further defines the nozzle exit orifice.

4. The processing head assembly of claim 3, in which the nozzle exit orifice surrounds the fabrication energy outlet.

5. The processing head assembly of claim 2, in which:
the upper processing head further includes a shield gas port coupled to the body and operably coupled to a shield gas supply; and
the lower processing head further includes a shield gas interface coupled to the base and configured to detachably couple to the shield gas port.

6. The processing head assembly of claim 5, in which:
the upper processing head further includes a coolant port coupled to the body and operably coupled to a coolant supply; and
the lower processing head further includes a coolant interface coupled to the base and configured to detachably couple to the coolant port.

7. The processing head assembly of claim 6, in which the feed powder/propellant interface, shield gas interface, coolant interface, and fabrication energy interface are configured to respectively couple to the feed powder/propellant port, shield gas port, coolant port, and fabrication energy port simultaneously as the base is coupled to the socket.

8. The processing head assembly of claim 2, in which:
the upper processing head further includes an enclosure coupled to the body and defining the fabrication energy port, and a first mirror disposed in the enclosure and optically coupled to the fabrication energy port; and
the lower processing head further includes a second mirror disposed in the optic chamber, the second mirror being configured to optically couple with the first mirror when the base of the lower processing head is coupled to the socket of the upper processing head.

9. The processing head assembly of claim 2, in which the fabrication energy supply comprises a laser.

10. The processing head assembly of claim 1, in which the upper processing head comprises a spindle of the machine tool.

11. A machine tool for use with a feed powder/propellant supply and a fabrication energy supply, the machine tool comprising:
a first tool holder carrying a substrate;
a second tool holder;
a processing head assembly including:
an upper processing head coupled to the second tool holder and including a body defining a socket, and a feed powder/propellant port coupled to the body and operably coupled to the feed powder/propellant supply; and
a lower processing head including a base configured to be releasably coupled to the socket, and a nozzle coupled to the base and defining a feed powder/propellant interface configured to detachably couple to the feed powder/propellant port and a nozzle exit orifice fluidly communicating with the feed powder/propellant interface;
a fabrication energy outlet operatively coupled to the fabrication energy supply; and
machine control circuitry operatively coupled to the first tool holder, the second tool holder, and the fabrication energy outlet, the machine control circuitry comprising one or more central processing units and one or more memory devices, the one or more memory devices storing instructions that, when executed by the one or more central processing units, cause the machine control circuitry to:
cause relative movement of the first tool holder, second tool holder, and fabrication energy outlet to direct fabrication energy and feed powder/propellant toward a target area on the substrate, thereby to perform an additive manufacturing process during which material is added to the substrate.

12. The machine tool of claim 11, in which:
the upper processing head further includes a fabrication energy port coupled to the body and operably coupled to the fabrication energy supply;
the fabrication energy outlet is incorporated into the lower processing head; and
the lower processing head further includes:
a fabrication energy interface coupled to the base and configured to detachably couple to the fabrication energy port;
an optic chamber disposed between the fabrication energy interface and the fabrication energy outlet; and
a focusing optic disposed in the optic chamber.

13. The machine tool of claim 12, in which the nozzle further defines the nozzle exit orifice, and in which the nozzle exit orifice surrounds the fabrication energy outlet.

14. The machine tool of claim 12, in which:
the upper processing head further includes a shield gas port coupled to the body and operably coupled to a shield gas supply; and
the lower processing head further includes a shield gas interface coupled to the base and configured to detachably couple to the shield gas port.

15. The machine tool of claim 14, in which:
the upper processing head further includes a coolant port coupled to the body and operably coupled to a coolant supply; and
the lower processing head further includes a coolant interface coupled to the base and configured to detachably couple to the coolant port.

16. The machine tool of claim 15, in which the feed powder/propellant interface, shield gas interface, coolant interface, and fabrication energy interface are configured to respectively couple to the feed powder/propellant port, shield gas port, coolant port, and fabrication energy port simultaneously as the base is coupled to the socket.

17. The machine tool of claim 12, in which:
the upper processing head further includes an enclosure coupled to the body and defining the fabrication energy port, and a first mirror disposed in the enclosure and optically coupled to the fabrication energy port; and
the lower processing head further includes a second mirror disposed in the optic chamber, the second mirror being configured to optically couple with the first mirror when the base of the lower processing head is coupled to the socket of the upper processing head.

18. The machine tool of claim 11, in which the upper processing head comprises a spindle.

19. The machine tool of claim 11, further comprising:
a tool changer assembly; and
a second lower processing head carried by the tool changer assembly and including a second base configured to be releasably coupled to the socket, and a second nozzle coupled to the second base and defining a second feed powder/propellant interface configured to detachably couple to the feed powder/propellant port and a second nozzle exit orifice;
in which the machine control circuitry is further operatively coupled to the tool changer assembly, and the instructions further cause the machine control circuitry to manipulate the second tool holder and tool changer assembly to automatically remove the lower processing head from the socket and attach the second lower processing head to the socket.

20. A machine tool for use with a feed powder/propellant supply and a fabrication energy supply, the machine tool comprising:
a first tool holder coupled to a substrate;
a second tool holder;
a processing head assembly including:
an upper processing head coupled to the second tool holder and including:
a body defining a socket;
a feed powder/propellant port coupled to the body and operably coupled to the feed powder/propellant supply;
a fabrication energy port coupled to the body and operably coupled to the fabrication energy supply; and
a lower processing head including:
a base configured to be releasably coupled to the socket;
a fabrication energy interface coupled to the base and configured to detachably couple to the fabrication energy port;
a nozzle coupled to the base and defining a feed powder/propellant interface configured to detachably couple to the feed powder/propellant port, a nozzle exit orifice fluidly communicating with the feed powder/propellant interface, and fabrication energy outlet operably coupled to the fabrication energy interface;
an optic chamber disposed between the fabrication energy interface and the fabrication energy outlet; and
a focusing optic disposed in the optic chamber; and
machine control circuitry operatively coupled to the first tool holder and the second tool holder, and the fabrication energy outlet, the machine control circuitry comprising one or more central processing units and one or more memory devices, the one or more memory devices storing instructions that, when executed by the one or more central processing units, cause the machine control circuitry to:
cause relative movement of the first tool holder and second tool holder to direct fabrication energy and feed powder/propellant toward a target area on the substrate, thereby to perform an additive manufacturing process during which material is added to the substrate.
